(19) United States
(12) Patent Application Publication
(10) Pub. No.: US 2024/0100480 A1
(43) Pub. Date: Mar. 28, 2024

(54) PROCESS FOR PRE-TREATING RENEWABLE FEEDSTOCKS

(71) Applicant: SHELL OIL COMPANY, Houston, TX (US)

(72) Inventors: Johannes Leendert Willem Cornelis DEN BOESTERT, Amsterdam (NL); Johannes HAAN, Amsterdam (NL); Amsterdam VAN DE WOUW, Amsterdam (NL); Arian NIJMEIJER, Amsterdam (NL)

(21) Appl. No.: 18/253,809

(22) PCT Filed: Dec. 16, 2021
(86) PCT No.: PCT/EP2021/086199

§ 371 Date: May 22, 2023

(30) Foreign Application Priority Data
Dec. 17, 2020 (EP) 20215005.8

(51) Int. Cl. B01D 61/02; B01D 65/02; B01D 69/10; B01D 71/02; B01D 71/76

(52) U.S. Cl. CPC B01D 61/027; B01D 65/02; B01D 69/10; B01D 71/02; B01D 71/76; B01D 2311/02; B01D 2311/2649; B01D 2325/02833; B01D 2325/34; B01D 2325/36

(57) ABSTRACT

The invention relates to pre-treating an oil derived from a renewable feedstock to remove at least a portion of one or more contaminants by filtering the oil with a nanofiltration membrane. The resulting permeate oil has a reduced concentration of the contaminant relative to the feed stream to the nanofiltration membrane.

### FIELD OF THE INVENTION

The present invention relates to a process for pre-treating a renewable feedstock for production of fuels and/or chemicals.

### BACKGROUND OF THE INVENTION

The increased demand for energy resulting from worldwide economic growth and development has contributed to an increase in concentration of greenhouse gases in the atmosphere. This has been regarded as one of the most important challenges facing mankind in the 21st century. To mitigate the effects of greenhouse gases, efforts have been made to reduce the global carbon footprint. The capacity of the earth's system to absorb greenhouse gas emissions is already exhausted. Accordingly, there is a target to reach net-zero emissions by 2050. To realize these reductions, the world is transitioning away from solely conventional carbon-based fossil fuel energy carriers. A timely implementation of the energy transition requires multiple approaches in parallel. For example, energy conservation, improvements in energy efficiency and electrification may play a role, but also efforts to use renewable resources for the production of fuels and fuel components and/or chemical feedstocks.

For example, vegetable oils, oils obtained from algae, and animal fats are seen as new sources for fuel production. Also, deconstructed materials are seen as a potential source for renewable fuels materials, such as pyrolyzed recyclable materials or wood.

Renewable materials may comprise materials such as triglycerides with very high molecular mass and high viscosity, which means that using them directly or as a mixture in fuel bases is problematic for modern engines. On the other hand, the hydrocarbon chains that constitute, for example, triglycerides are essentially linear and their length (in terms of number of carbon atoms) are compatible with the hydrocarbons used in/as fuels. Thus, it is attractive to transform triglyceride-comprising feeds in order to obtain good quality fuel components. As well, renewable feedstocks contain more oxygenates that are unsaturated compounds as well.

Accordingly, renewable materials are processed in a hydrotreating step to remove the oxygenates from the feed. Reactions in the hydrotreating step include hydrogenation, hydrodeoxygenation, hydrodenitrogenation, hydrodesulphurization, and combinations thereof. Other processing steps hydroisomerization, selective cracking, and/or hydrodearomatization before, during, or after the hydrotreating step. As well, the renewable feedstock may be processed before hydrotreating in an oligomerization and/or ketonization step. These processing steps are typically catalytic.

A challenge for processing renewable feedstocks in these catalytic reactions is that there are often undesirable solids, metals and/or gum-like materials in the feedstock. As a result, many conventional processes require good quality feedstocks that meet certain specifications before processing. This requirement increases the price of desirable feedstock, as well leaving an untapped resource of undesirable feedstocks.

In order to produce an ultimate fuel or chemical product that will meet stringent specifications, reduce deleterious effects on catalyst and equipment, and/or to reduce undesirable side reactions during processing, it would be desirable to pre-treat the renewable feedstock to remove contaminants prior to processing the renewable feedstock.

US2016/0257889A1 (Abdullah et al.) describes a method for pre-processing bio-oil before hydrotreatment. Biomass is pyrolyzed to produce a bio-oil. The bio-oil is coarse-filtered to remove particles having a particulate diameter greater than 10 μm, optionally followed by fine-filtering to remove particles having a diameter greater than 5 μm. The filtered bio-oil is then treated with an ion exchange resin to remove inorganic species. Abdullah et al. generally indicate that the filter may be a bag filter element, a metal mesh element or a ceramic filter element.

Traynor et al. (US2015/0175896A1, US2012/0017495A1 and US2012/0017494A1) disclose methods for deoxygenating and esterifying biomass-derived pyrolysis oils. The pyrolysis oil may be pre-treated by filtering to form a low-solids oil. Filter medium include nitrocellulose, cellulose acetate, glass fibre, polymeric wire mesh, and sintered metal. The filtered oil is passed to an ion exchange resin to remove metals.

Others (U.S. Pat. No. 5,705,722, US2018/0010051A1) generally mention pre-treating feedstock by filtering. US2018/0010051A1 mentions that feedstocks having concentrations over 10 wt. % of free fatty acids and the rest predominantly triglycerides form agglomerates or particles that clog filters.

Conventional filters for filtering oils include cartridge or back-wash filters. However, there is a problem with filters clogging and/or fouling in a relatively short timeframe. In addition, the cut-off regime of conventional filters is such that only particles are removed and not any molecular matter. Moreover, when conventional filters become clogged/fouled, they must be disposed of, together with the clogging/fouling material, which may have an adverse impact on the environment.

There is a need for an improved process for pre-treating renewable feedstocks.

### SUMMARY OF THE INVENTION

According to one aspect of the present invention, there is provided a process for pre-treating renewable feedstocks for the production of fuels and/or chemicals, the process comprising the steps of: (a) providing an oil derived from a renewable source, the oil having a contaminant; (b) providing a nanofiltration membrane; and (c) filtering the oil with the nanofiltration membrane to produce a permeate oil having a reduced concentration of the contaminant.

### BRIEF DESCRIPTION OF THE DRAWINGS

The process of the present invention will be better understood by referring to the following detailed description of preferred embodiments and the drawings referenced therein, in which:

FIG. 1 illustrates one embodiment of the process of the present invention having a single nanofiltration unit;

FIG. 2 illustrates another embodiment of the process of the present invention having a staged nanofiltration unit;

FIG. 3 illustrates a further embodiment of the process of the present invention having a self-cleaning filter unit preceding a nanofiltration unit;

FIG. 4 illustrates still another embodiment of the process of the present invention having a polishing unit following a nanofiltration unit;

FIGS. 5 and 6 are graphical illustrations depicting permeability vs. permeate recovery for different operating pressures in Example 2 herein; and

FIG. 7 is a graphical illustration depicting the effect of a backpulse on permeability over time in Example 2 herein.

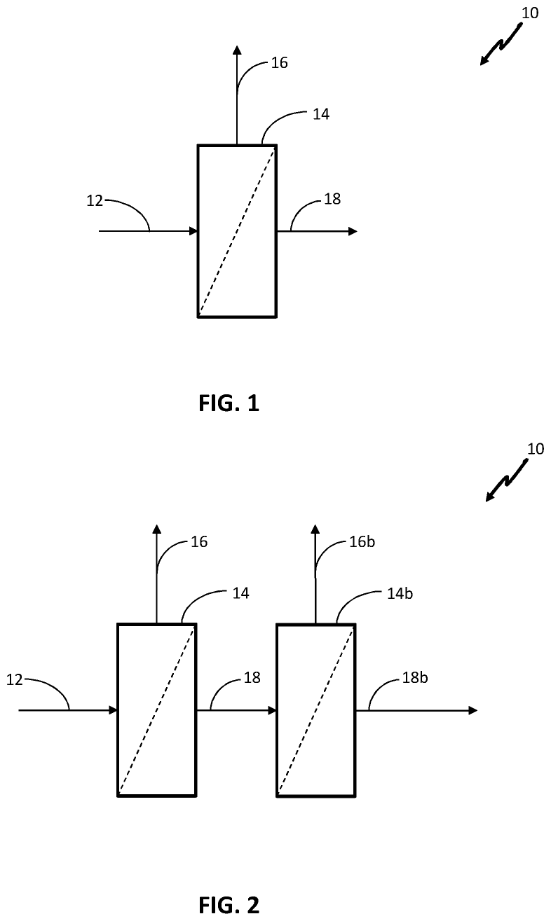

### DETAILED DESCRIPTION OF THE INVENTION

In accordance with the process of the present invention, an oil derived from a renewable feedstock is pre-treated to remove at least a portion of one or more contaminants by filtering the oil with a nanofiltration membrane. The resulting permeate oil has a reduced concentration of the contaminant relative to the feed stream to the nanofiltration membrane. A further advantage of the process of the present invention is that the separation method also contributes the overall sustainability of the renewable feedstock process. Membrane and related filtration separation processes are pressure-driven processes to achieve the required mass-transfer for the separation. This in comparison to other separation methods, such as distillation, whereby the mass-transfer has a temperature-driven relation. These methods are often engaged with the application of fossil fuels for heat generation. Conversely, in membrane and related filtration separation methods, electricity is utilized, which creates the opportunity to apply this separation from a sustainable electrification source, such as derived via solar panel and/or windmill methods. These sustainable energy delivery options will further contribute to support the objective of the desired reduction of the global carbon footprint.

Oils Derived from Renewable Sources

The renewable feedstock includes materials suitable for the production of fuels, fuel components and/or chemical feedstocks. A preferred class of renewable materials are bio-renewable fats and oils comprising triglycerides, diglycerides, monoglycerides and free fatty acids or fatty acid esters derived from bio-renewable fats and oils. Examples of such fatty acid esters include, but are not limited to, fatty acid methyl esters, fatty acid ethyl esters. The renewable fats and oils include vegetable oils, animal oils and combination thereof, including both edible and non-edible fats and oils. Examples of these renewable fats and oils include, without limitation, algal oil, brown grease, canola oil, carinata oil, castor oil, coconut oil, colza oil, corn oil, cottonseed oil, fish oil, hempseed oil, jatropha oil, lard, linseed oil, milk fats, mustard oil, olive oil, palm oil, peanut oil, rapeseed oil, sewage sludge, soy oils, soybean oil, sunflower oil, tall oil, tallow, used cooking oil, yellow grease and combinations thereof.

Another preferred class of renewable materials are oils derived from biomass and waste liquefaction processes. Examples of such liquefaction processes include, but are not limited to, (hydro)pyrolysis, hydrothermal liquefaction, plastics liquefaction, and combinations thereof.

The oils derived from renewable feedstocks often contain contaminants. As a result, many conventional processes require good quality feedstocks that meet certain specifications before processing. This requirement increases the price of desirable feedstock, as well leaving an untapped resource of undesirable feedstocks.

Contaminants may include, without limitation, free solids; phosphorus, chlorine, sodium, iron, magnesium, calcium, aluminum, copper, manganese, silicon and/or zinc, in elemental or molecular form; phospholipids, and combinations thereof.

The process of the present invention is applicable to all oils derived from renewable vegetable and animal feedstocks. However, the inventive process is particularly advantageous for pre-treating renewable feedstocks that are heavily contaminated with contaminants such as, solids, metals and/or gum-like materials. Such heavily contaminated renewable feedstocks, in particular, include tallow, used cooking oil, and combinations thereof.

### Nanofiltration Membrane

In the present invention, a nanofiltration membrane is provided and used to filter the oil derived from a renewable source. The nanofiltration membrane may be organophilic or hydrophilic. In a preferred embodiment, the nanofiltration membrane is hydrophilic. Generally, it would be understood that a hydrophobic membrane would be appropriate for filtering hydrocarbon streams (see, for example, U.S. Pat. No. 6,488,856). Further, it is generally understood that hydrophobic nanofiltration membranes are less prone to fouling. The inventors have surprisingly discovered that a hydrophilic nanofiltration membrane provides improved performance in the pre-treatment of renewable feedstocks.

The material of the membrane is selected to be compatible with the components contained in the liquid hydrocarbon feedstock stream. Preferably, the nanofiltration membrane is an inorganic membrane, a polymer membrane, or a combination thereof. More preferably, the nanofiltration membrane is a ceramic membrane or a composite ceramic membrane.

Nanofiltration membranes have an asymmetric structure. An asymmetric structure provides an amorphous pore network with a smallest or controlling pore size that could be suitable for the process.

Preferably, the nanofiltration membrane has a molecular weight cut-off value (MWCO) in a range of from 8,000 to 100,000 Daltons (Da), more preferably in a range of from 8,500 to 20,000 Da. By MWCO, we mean 90% of solute having a specified molecular weight is retained by the membrane. Preferably, the nanofiltration membrane has an average pore size in a range of from 5 to 30 nm, more preferably in a range of from 10 to 30 nm.

In one embodiment, the nanofiltration membrane is a composite membrane of a first membrane layer and a second membrane layer. The first membrane layer provides support and can be a porous polymer, a porous cross-linked polymer, a porous pyrolyzed polymer, a porous pyrolyzed cross-linked polymer, a porous metallic structure, a hybrid metallic-polymer porous structure, or a porous ceramic structure. The second membrane layer can be formed on the porous support structure and is a polymer membrane layer. In one embodiment, the composite membrane is a composite of ceramic and polymer, for example a polymer membrane layer on a ceramic membrane layer or a polymer grafted onto a ceramic membrane.

Example of polymeric materials suitable to make the nanofiltration membrane are polyimides. These are well known in the art as one of the most promising polymer materials for hydrocarbon separations. Suitable commercially available polymeric materials comprise MATRIMID 5218™ (Huntsman), PYRALIN PI 2566™ (6FDA-ODA polyamic acid, by Du Pont), P84™ (Lenzing), TORLON™ (Solvay), polyphenylene oxide NORYL™ (PPO, Sabic), polyetherimide (Sigma Aldrich) and a BPDA-based polyimide in hollow fibre form (Ube). Other polymeric materials suitable for making dense membranes suitable for this invention are polysiloxane-based, in particular from poly(dimethyl siloxane) (PDMS).

Examples of suitable cross-linked polymeric membranes are membranes comprising per-fluoropolymers derived from perfluoro cycloalkene (PFCA), ethylene, vinyl fluoride (VF1), vinylidene fluoride (VDF), trifluoro ethylene (TrFE), tetrafluoroethylene (TFE), chlorotrifluoroethylene (CTEF), propylene, hexafluoropropylene (HFP), perfluoropropylvinylether (PPVE), perfluoromethylvinylether (PMVE) or a combination thereof which further may contain at least one chlorinated monomer such as chlorofluoroethylene (CFE), chlorotrifluoroethylene (CTFE), 2-chloro-3,3,3-trifluoropropene, 1-chloro-3,3,3-trifluoropropene. The copolymer may further contain at least one other unit derived from a fluorinated monomer, which may be chosen from: tetrafluoroethylene (TFE), hexafluoropropylene (HFP), 2-(trifluoromethyl)acrylic acid, trifluoro-propene, tetrafluoropropene, hexafluoroisobutylene, (perfluorobutyl)ethylene, pentafluoropropene, perfluoro-alkyl ethers such as PMVE, PEVE, and PPVE and mixtures thereof. Preferably, the membrane is a per-fluoropolymer copolymerized with tetrafluoroethylene. More generally, suitable polymers may include glassy polymers, polymers with high intrinsic micro porosity, and/or polymers that are known to form a porous carbon structure when the cross-linked polymer is exposed to pyrolysis conditions. Other polymeric materials suitable for making the porous support of a membrane are PolyAcryloNitrile (PAN), PolyAmidelmide+TiO2 (PAT), PolyEtherlmide (PEI), PolyvinylideneDiFluoride (PVDF), and porous PolyTetraFluoroEthylene (PTFE).

When a polymer is used to form the nanofiltration membrane, it can be cross-linked and/or pyrolyzed prior to use to increase the stability of the membrane structure. Furthermore, cross-linking may be desirable prior to pyrolysis. The polymeric membrane structure can be converted to a porous carbon structure after pyrolysis where the desirable pore structure can be maintained by cross-linking of the material.

Preferably, the nanofiltration membrane is a ceramic membrane or a functionalized inorganic membrane, in particular, a functionalized ceramic membrane. Hereby, functionalization refers to the chemical surface modification, wherein “surface’ is understood to comprise the (macroscopic) outer surface of the inorganic membrane as well as the inner pore surfaces of the matrix making up the inorganic membrane. It typically involves the replacement of the hydroxyl (—OH) groups provided on the surface of the inorganic membrane by organic functional groups. Preferably, the functionalized internal and external surface of the membrane reduces fouling relative to a non-functionalized ceramic membrane. For example, by functionalizing the membrane surface, surface wettability may be improved, which may enhance the permeability.

Ceramic nanofiltration membranes are known to comprise chemically inert, high-temperature stability, and anti-swelling properties when subjected to optimal conditions. Such membranes include narrow and well-defined pore size distribution, in comparison to polymeric membranes, which allows ceramic membranes to achieve a high degree of particulate removal at high flux levels.

Ceramic nanofiltration membranes may include, for example, mesoporous titania, mesoporous gamma-alumina, mesoporous zirconia, and mesoporous silica. Suitable inorganic nanofiltration membranes may also consist of inorganic materials (e.g., sintered metals, metal oxide and metal nitride materials) including a porous support, one or more layers of decreasing pore diameter, and an active or selective layer (e.g., gamma-alumina, zirconia, etc.) covering an internal surface of the membrane element.

Commercially available ceramic nanofiltration membranes often have at least two layers including a macroporous support layer and a thin selective layer, commonly there is a mesoporous intermediate layer between the microporous support and the selective layer. The thickness of the selective membrane layer determines the transport rate across the membrane. It can be selected in the range of from 0.08 μm to 5 μm. In addition, the second membrane layer may be provided with enough pores to enable acceptable transport rates. The amount of pores is determined by the specific surface area of the second membrane layer which can be measured by nitrogen adsorption (BET) and can be in the range of from 10 m²/g to 1000 m²/g for pores having sizes in the range of from 5 Angstroms to 100 Angstroms.

Functionalized inorganic membranes can be fabricated by 1) grafting organic molecules on the surface of the inorganic material by means of post-modification treatment(s), 2) building-in organic linkers within the inorganic matrix. The basis of such membranes is that the inorganic support provides mechanical strength to the membrane without significant flow resistance.

The support may be composed of ceramics, glass ceramics, glasses, metals, and combinations thereof. Examples of suitable supports include, but are not limited to, metals (such as, stainless steels or Ni-alloys), metal oxides (such as but not limited to, alumina (e.g., alpha-alumina, delta-alumina, or combinations thereof), cordierite, mullite, aluminium titanate, titania, ceria, magnesia, silicon carbide, zirconia, zircon, zirconates, zirconia-spinel, spinel, silicates, borides, alumino-silicates, porcelain, lithium alumino-silicates, feldspar, magnesium alumino-silicates, and fused silica.

Nominal pores size of the support typically ranges from about 1 μm to about 10 μm, and in some embodiments, less than about 1 μm, particularly less than about 800 nm. The preferred pore size of the inorganic porous support is in the range of from 0.2 to 0.5 μm. Commercially available inorganic porous supports can be sourced from many different sources known to those skilled in the art, including, without limitation, Inopor GmbH, Hyflux LTD., Fraunhofer IKTS, Atech, Liqtech, TAMI, and Evonik MET.

The functionalization of the surface of the inorganic porous support may be carried out by binding an organic functional group linked to the inorganic membrane via a carbon bond or and oxygen bond to a component within the inorganic membrane which can be a metal such as Ti, Zr, Al, Si, Ge, Mg, Ca, Ba, Ce, Gd, Sr, Y, La, Hf, Fe, Mn, or a combination thereof. Preferably, the organic functional group is selected from the group consisting of (a) haloalkyl, preferably fluoroalkyl or perfluoroalkyl, more preferably fluoro-C1-C16-alkyl or perfluoro-C1-C16-alkyl, more preferably fluoro-C1-C8-alkyl or (per)fluoro-C1-C8-alkyl; (b) aryl, preferably C6-C16 aryl, more preferably C6-C10 aryl; and (c) haloaryl, preferably fluoroaryl or perfluoroaryl, more preferably fluoro-C6-C16-aryl or perfluoro-C6-C16-aryl, more preferably fluoro-C6-C10-aryl or perfluoro-C6-C10-aryl. Furthermore, Grignard reagents are reported to be used for functionalization of a membrane surface (Hosseingabadi S R, et al., “Solvent-membrane-solute interactions in organic solvent nanofiltration (OSN) for Grignard functionalized ceramic membranes: Explanation via Spiegler-Kedem theory”, Journal of Membrane Science 513 (2016) 177-185). Further details of the functional groups that could be provided to the inorganic membrane are described in U.S. Ser. No. 10/730,022.

A functionalized hybrid membrane separates compounds on the basis of a partition coefficient (P), which describes the propensity of a neutral (uncharged) compound to dissolve in an immiscible biphasic system of lipids and water. The partition coefficient is a measure of how much of a solute dissolves in a water portion versus an organic portion. The measure may be reported as a ‘Log P’ value, where it is calculated from the log 10 of P where P is a ratio of the concentration of a compound in an organic phase over the concentration of the compound in an aqueous phase. Thus, because of the functionalization of the porous inorganic membrane surface, the membrane, having a hydrophobic nature, allows permeating compounds having a relatively high log P value and retains compounds having a relatively low log P value. For instance, aliphatic compounds have a higher log P value than other components, and heteroatom containing organic compounds have correspondingly a lower log P value. This means that the membrane will allow aliphatic compounds to pass through by affinity. The determination of the Log P values of the feedstock components can be made by methods known in the art, and such information can be used to determine the selection of the functional group for the membrane. For instance, it is possible to select a polar functional group for functionalizing of the membrane surface. In that case, compounds with a relatively lower Log P would preferentially permeate through the membrane while compounds with a relatively higher Log P would remain in the retentate.

### Nanofiltration Unit

The nanofiltration membrane may be arranged as tubular, multi-tubular, hollow fiber (capillary), or spiral-wound modules. Spiral-wound modules typically comprise a membrane assembly of two membrane sheets between which a permeate spacer sheet is sandwiched, and where the membrane assembly is sealed at three sides. The purpose of the permeate spacer sheet is to support the main membrane against feed pressure and carry permeate to central permeate tube. A fourth side is connected to a permeate outlet conduit such that the area between the membranes is in fluid communication with the interior of the conduit. On top of the one of the membranes, a feed spacer sheet is arranged, and the assembly feed spacer sheet is rolled up around the permeate outlet conduit to form a substantially cylindrical spirally wound membrane module. The spirally wound module is placed in a specially-made casing which includes ports for hydrocarbon mixtures and permeate.

The nanofiltration membranes used in the process of the present invention may operate as cross-flow nanofiltration membranes. Cross-flow filtration involves flowing the feed stream parallel, or tangentially, along a feed side of the nanofiltration membrane, rather than frontally passing through the membrane.

A parallel flow of feed, combined with turbulence created by the cross-flow velocity, continually sweeps away particles and other material that would otherwise build up on the nanofiltration membrane. In this way, cross-flow filtration creates a shearing effect on the surface of the membrane that prevents build-up of retained components and/or a potential fouling layer at the membrane surface. In the present invention, cross-flow filtration is preferred in order to prevent build-up of retained particles and/or a potential fouling layer on the membrane caused by physical or chemical interactions between the membrane and various components present in the feed.

### Nanofiltration Step

Referring now to the drawings, in embodiments of the process of the present invention 10, a feed stream 12 of oil derived from a renewable source is fed to a nanofiltration unit 14. A retentate stream 16 from the nanofiltration unit 14 comprises at least a portion of the contaminants contained in the feed stream 12. A permeate stream 18 from the nanofiltration unit 14 comprises a permeate oil with reduced concentration of contaminants relative to the feed stream 12.

The quality of such permeate oil 18 may be such that it needs no further treatment before any subsequent hydrotreating step, including hydrogenation, hydrodeoxygenation, hydrodenitrogenation, hydrodesulphurization, and combinations thereof, hydroisomerization, selective cracking, and/or hydrodearomatization before, during, or after the hydrotreating step, and/or oligomerization and/or ketonization before hydrotreating.

In accordance with the present invention, a contaminant, such as solids, metals and/or gum-like materials are removed in the retentate stream 16 to provide a permeate oil 18 that has a reduced contaminant concentration as compared to the feed stream. In the case of solid contaminants, the reduced concentration is preferably in a range of from 1% to <0.01 wt. % of the permeate oil 18. In the case of metallic contaminants, the reduced concentration of total metals is preferably in a range of from 80 to <10 ppmw, more preferably in a range of from 20 to 5 ppmw. In a preferred embodiment, the concentration of iron is in a range of from 10 ppm to <0.1 ppmw, calculated on an element basis. In the case of gum-like materials, components having a molecular weight of 3000 D and higher are reduced.

The preferred operating temperature range may be determined by the nature of the feed stream 12 to the nanofiltration unit 14 for the lower limit and the temperature resistance of the membrane for the upper limit. Preferably, the filtration step is conducted at a temperature in a range of from 4 to 200° C., depending on the type of nanofiltration membrane used. For polymeric nanofiltration membranes, the filtration step is preferably conducted at a temperature in a range of from 4 to 150° C., more preferably in a range of from 20 to 110° C. For ceramic nanofiltration membranes and ceramic-based composite nanofiltration membranes, the filtration step is preferably conducted at a temperature in a range of from 20 to 200° C., more preferably in a range of from 60-200° C.

Differential pressure drives the permeating molecules through the membrane. The pressure of the feed stream 12 to the nanofiltration unit 14 may be increased to a pressure in the range of from 5 to 100 bar (0.5 to 10 MPa), preferably of from 10 to 40 bar (1 to 4 MPa), more preferably of from 15 to 30 bar (1.5 to 3 MPa). The permeate stream 18 may have a pressure in the range of from 1 to 10 bar (0.1 to 11V1 Pa). The retentate stream 16 may have a pressure in the range of from 1 to 40 bar (0.1 to 4 MPa).

The permeate stream 18 may be stored in an intermediate storage and/or transport vessel before being further processed. Alternatively, as illustrated in FIG. 4, the permeate stream 18 may be subjected to a final polishing step, before being provided to a hydrotreating reactor.

In the embodiment of FIG. 2, the permeate stream 18 from the nanofiltration unit 14 is fed to a second staged nanofiltration unit 14b. The membrane of the staged nanofiltration unit 14b may be the same or different as in the nanofiltration unit 14. In one embodiment, for example, the membrane of nanofiltration unit 14 may have a larger average pore size than that membrane of nanofiltration unit 14b. For example, without limitation, the membrane in nanofiltration unit 14 may have an average pore size of 30 nm, while the membrane in nanofiltration unit 14b may have an average pore size of 10 nm. As another example, the surface of the membrane in nanofiltration unit 14 may have a different functional group, as compared to the membrane in nanofiltration unit 14b. As yet another example, one of the membranes in nanofiltration unit 14 or nanofiltration unit 14b may be hydrophilic, while the other is organophilic.

Retentate stream 16b from the nanofiltration unit 14b comprises at least a portion of the contaminants contained in the permeate stream 18. Permeate stream 18b from the nanofiltration unit 14b comprises a permeate oil with reduced concentration of contaminants relative to the feed stream 12.

In a preferred embodiment, the nanofiltration unit 14, 14b, is operated with a periodic backpulse. A periodic backpulse of the nanofiltration membrane allows for ongoing cleaning of the membrane without the need for downtime. Preferably, the nanofiltration membrane is backpulsed with a pulse of pressure in a range of from 10 to 15 bar for a time in a range of from 1 to 5 seconds. The backpulse is preferably conducted on a periodic basis in a range of from 10 minutes to 30 minutes.

In another embodiment, the nanofiltration step may comprise a backwash cycle, which involves changing the flow direction of fluid through the nanofiltration membrane to remove particles and/or an oily layer that have become attached to the nanofiltration membrane on the retentate side and/or that have become trapped in the openings of the nanofiltration membrane. After detaching in the backwash cycle, the particles and/or oily layer may then be removed via a retentate outlet and the normal nanofiltration step may be resumed.

The change in flow direction in a backwash cycle may be achieved by having a cleaning fluid on the filtrate side of the nanofiltration membrane at a pressure that is higher than the pressure of the fluid to be filtered on the retentate side of the membrane. The pressure difference causes the cleaning fluid to flow through the nanofiltration membrane in a direction opposite to the direction of normal flow, that is to say, opposite to the direction of normal flow of the fluid to be filtered. Such “normal flow” refers to non-cleaning time periods.

The cleaning fluid used in the backwash cycle can be any fluid known to be suitable to a person skilled in the art. A cleaning fluid that is especially preferred is permeate resulting from the nanofiltration step. It is especially advantageous to use permeate for cleaning the membrane by which the permeate has been obtained because in that way no additional compounds are introduced. This simplifies operation and/or reduces risk of contamination.

A backwash pump may be used for the backwash cycle. Alternatively, a backwash pressure difference may be achieved by reducing the pressure of the fluid to be filtered on the retentate side of the nanofiltration membrane to a pressure that is below the pressure of a cleaning fluid on the permeate side of the nanofiltration membrane. Such reduction in pressure can be achieved, for example, by removing overpressure or reducing the pressure to below atmospheric pressure. As the remainder of a nanofiltration unit is generally at a substantially greater atmospheric pressure, it often suffices to lower the pressure of a retentate outlet to atmospheric pressure.

A backwash in the nanofiltration step may be triggered in a variety of ways. For example, a backwash may be initiated once the pressure of the fluid to be filtered on the retentate side of the nanofiltration membrane increases to a predetermined threshold due to relatively large particles blocking a portion of the openings of the membrane. This is preferred in a case where the feed contains a relatively high amount of such large particles and/or where particles, such as phospholipids, are sticky and prone to penetrate (be dragged) into and thereby also block the openings of the nanofiltration membrane. A pressure-based self-cleaning backwash is preferred as in such case there is a minimal backwash usage due to its backwash efficiency. In conventional (non-self-cleaning) backwash, a substantially higher volume of washing solvent is to be used to achieve the same effect. In case the feed contains a relatively low amount of such large particles and/or sticky particles, a timer-based self-cleaning backwash (e.g. once per hour) may be more suitable.

Prior to the nanofiltration step, it may be desirable to separate larger solid material from the feed stream 12 by, for example, without limitation, pre-coat filtration, conventional backwash filtration, centrifuge, a self-cleaning filtration unit, and combinations thereof.

### Self-Cleaning Filtration (SCF)

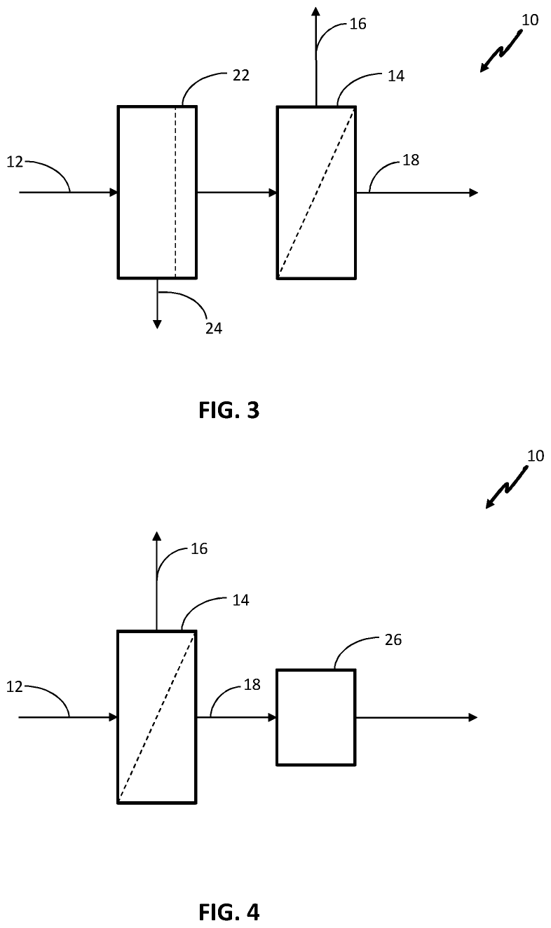

In the embodiment of the present invention illustrated in FIG. 3, the process 10 further includes a self-cleaning filtration step. The self-cleaning filtration step removes solids in the oil-derived from renewable feedstocks to reduce the burden on the nanofiltration unit 14. The filtration screen used in a SCF unit 22 may comprise a mesh, which may be a metal mesh or a polymeric mesh. The filtrate is then provided as feed to the nanofiltration unit 14. The filtration-reject 24 may be recycled, discarded and combinations thereof.

Within the present specification, a “mesh” means a structure made of connected strands of metal, fiber or other flexible/ductile material, with evenly spaced openings between them. This may also be referred to as a “wire-mesh”. The mesh may be flexible but may also be more rigid, such as a reinforced polymeric mesh. A suitable polymeric mesh material is TEFLON®. For the filtration screen, fibrous material may be used, such as metal fibres, polymeric fibres and/or ceramic fibres. Preferably, any polymeric material in the filtration screen to be used in the SCF unit 22 is resistant to hydrocarbons, such as vegetable oils and animal oils. This implies that the filtration screen does not dissolve in the vegetable oils and animal oils that are being treated.

The effective filter surface area of a filter, like the filtration screen used in the SCF unit 22, is the area through which fluid can actually pass. Filters using metal mesh tend to have a relatively high effective filter surface area. Therefore, it is preferred that the filtration screen used in the SCF unit 22 comprises metal mesh. Further, preferably, the filtration screen comprises at least 2 mesh layers. In this way, the mesh layers provide strength to each other. In a further preferred embodiment, the filter comprises at least 2 mesh layers which have been sintered together to provide a rigid and immobilized mesh structure, which gives a sharp and fixed particle separation.

The SCF step may comprise a backwash cycle by changing the flow direction of fluid through the filtration screen to remove particles that have become attached to the filtration screen on the retentate side and/or that have become trapped in the openings of the filtration screen. For example, contaminant particulates may be relatively sticky and therefore need to be detached from the filtration screen. Upon detachment, these particles may then be removed via a retentate outlet. Upon such removal, the normal filter cycle operation may be resumed, and advantageously more effective and full use may be made of the cleaned filtration screen.

Such change of flow direction in SCF may be achieved by having a cleaning fluid on the filtrate side of the filtration screen at a pressure that is higher than the pressure of the fluid to be filtered on the retentate side on the screen. This pressure difference results in that the cleaning fluid will flow through the filtration screen in a direction opposite to the direction of normal flow, that is to say, opposite to the direction of normal flow of the fluid to be filtered. Such “normal flow” refers to non-cleaning time periods.

The cleaning fluid used in self-cleaning filtration can be any fluid known to be suitable to a person skilled in the art. A cleaning fluid that is especially preferred is filtrate resulting from the SCF step. It is especially advantageous to use filtrate for cleaning the filtration screen by which the filtrate has been obtained because in that way no additional compounds are introduced. This allows easy operation and reduced risk of contamination.

The above-mentioned pressure difference may be achieved by reducing the pressure of the fluid to be filtered on the retentate side of the filtration screen to a pressure that is below the pressure of a cleaning fluid on the filtrate side of the filtration screen. Such reduction in pressure can comprise removing overpressure or reducing the pressure to below atmospheric pressure. As the remainder of a filter unit comprising the filtration screen generally is at substantially more than atmospheric pressure, it often suffices to lower the pressure of a retentate outlet to atmospheric pressure.

A backwash in the SCF step may be triggered in a variety of ways. For example, a backwash may be initiated once the pressure of the fluid to be filtered on the retentate side of the filtration screen reaches a certain threshold, for example 0.5 bar (0.05 MPa), because of relatively large particles blocking a portion of the openings of the filtration screen. This is preferred in a case where the feed contains a relatively high amount of such large particles and/or where particles, such as phospholipids, are sticky and prone to penetrate (be dragged) into and thereby also block the openings of the filtration screen. A pressure-based self-cleaning backwash is preferred as in such case there is a minimal backwash usage due to its backwash efficiency. In conventional (non-self-cleaning) backwash, a substantially higher volume of washing solvent is to be used to achieve the same effect. In case the feed contains a relatively low amount of such large particles and/or sticky particles, a timer-based self-cleaning backwash (e.g. once per hour) may be more suitable.

Thus, an advantage of using SCF screens is that the frequency of the backwash may be determined on the basis of the specific feed, that is to say the specific stream comprising vegetable oils and animal oils to be purified. For example, the backwash frequency may be determined by the relative amount of large particles to be removed from the feed. That is to say, the higher such amount the higher the backwash frequency should generally be. Another relevant factor is the relative “stickiness” of the particles in such feed. A higher backwash frequency is generally needed to remove contaminant particulates that may be relatively sticky.

Another advantage of using SCF screens is that there is no direct human exposure to vegetable oils and animal oils, which exposure is however a risk for example when manually replacing cartridge filters (that are not self-cleaning). Therefore, using SCF screens is beneficial to HSSE aspects in purifying vegetable oils and animal oils (HSSE=Health Safety Security Environment).

Furthermore, when using SCF screens, more vegetable oils and animal oils may end up in the resulting retentate stream. However, this loss of vegetable oils and animal oils may be minimized by minimizing the backwash duration and/or backwash frequency, for example by applying a relatively large pressure difference during a backwash.

Filtration screens (filters) for use in the SCF step can be obtained from the company Filtrex s.r.l., Italy. A filter that has been found to be especially suitable is the filter known as the Automatic Counterwash Refining (ACR) filter, which is commercially available from this company.

A preferred filter unit that may be used in the SCF step is a filter unit as described in WO2010070029, the disclosure of which is herein incorporated by reference. This filter unit comprises a perforated tube surrounded by hollow longitudinal projections comprising a filter having openings of at most 100 μm diameter in which the internal space of each of the hollow projections is in fluid communication with the inside of the perforated tube and which filter is regularly subjected to cleaning by treating each of the projections with cleaning fluid wherein the flow of cleaning fluid is opposite to the direction of normal flow. Such filter unit may be as described and may be used in a way as described at page 2, line 21 to page 5, line 24 of WO2010070029, the disclosure of which passage from WO2010070029 is herein incorporated by reference.

### Polishing

In the embodiment of the present invention illustrated in FIG. 4, the process 10 further includes a polishing step. A polishing unit 26 can be used for removal of trace contaminants. The polishing unit 26 may comprise sorption, stripping or washing units.

The polishing step may be conducted immediately after the nanofiltration step and/or immediately before the hydrotreating step. For example, if the feedstock is pre-treated at a site different from the hydrotreating step, it may be desirable to conduct the polishing step after the feedstock is transported to the site of the hydrotreating step.

### EXAMPLES

The following non-limiting examples of embodiments of the process of the present invention as claimed herein are provided for illustrative purposes only.

### Example 1

A used cooking oil was fed to a TiO₂ ceramic tubular membrane having a selective layer inside the tube. The membrane surface area was approximately 0.25 m². The used cooking oil was fed at a cross-flow velocity of 0.5-1 m/s and 120° C. feed temperature. The trans-membrane pressure ranged between 0.4 and 14 bar (0.04 and 1.4 MPa).

The permeate and retentate were collected and analysed for a number of elements, the more significant ones listed below. Table I compares the feed concentration with the permeate and retentate results for a 30 nm TiO₂ ceramic membrane, while Table II illustrates the results for a 10 nm TiO₂ ceramic membrane. The total metal rejection was 63% for the 30 nm membrane and 73% for the 10 nm membrane.

TABLE I

| | Feed | Permeate | Retentate | Rejection |
|---|---|---|---|---|
| Element | (mg/kg) | (mg/kg) | (mg/kg) | (%) |
| Al | <0.03 | <0.03 | <0.03 | |
| Ca | 0.6 ± 0.03 | 0.2 ± 0.03 | 0.8 ± 0.04 | 66.7 |
| Cu | 0.2 ± 0.1 | 0.05 | 0.2 ± 0.1 | 75.0 |
| Fe | <0.1 | <0.1 | 1.1 ± 0.01 | |
| Mg | 0.4 ± 0.03 | 0.1 ± 0.03 | 0.6 ± 0.03 | 75.0 |
| Mn | <0.05 | <0.05 | <0.05 | |
| Na | 5 ± 3 | 1.5 | 5 ± 3 | 70.0 |
| P | 5.2 ± 0.5 | 2.5 ± 0.5 | 5.9 ± 0.5 | 51.9 |
| Si | <0.3 | <0.3 | 0.8 ± 0.3 | |
| Zn | 0.8 ± 0.3 | 0.2 | 1.0 ± 0.3 | 75.0 |
| TOTAL | 12.2 | 4.6 | | 62.7 |

TABLE II

| | Feed | Permeate | Retentate | Rejection |
|---|---|---|---|---|
| Element | (mg/kg) | (mg/kg) | (mg/kg) | (%) |
| Al | <0.03 | <0.03 | <0.03 | |
| Ca | 0.6 ± 0.03 | 0.2 ± 0.03 | 1.9 ± 0.1 | 66.7 |
| Cu | 0.2 ± 0.1 | 0.03 | 0.2 ± 0.1 | 85.0 |
| Fe | <0.1 | <0.1 | 3.8 ± 0.2 | |
| Mg | 0.4 ± 0.03 | 0.03 ± 0.03 | 1.3 ± 0.07 | 92.5 |
| Mn | <0.05 | <0.05 | 0.1 ± 0.05 | |
| Na | 5 ± 3 | 1 | 6 ± 3 | 80.0 |
| P | 5.2 ± 0.5 | 1.9 ± 0.5 | 9.4 ± 0.5 | 63.5 |
| Si | <0.03 | <0.03 | 0.7 ± 0.3 | |
| Zn | 0.8 ± 0.3 | 0.15 | 2.3 ± 0.3 | 81.25 |
| TOTAL | 12.2 | 3.3 | | 72.9 |

### Example 2

Example 1 was repeated for a different used cooking oil feedstock. Table III illustrates the results for a 30 nm TiO₂ ceramic membrane, while Table IV illustrates the results for a 10 nm TiO₂ ceramic membrane. The higher rejection levels for the 10 nm membrane are more apparent in Example 2, as compared to Example 1. In particular, in view of the higher iron content in the used cooking oil feedstock of Example 2, the performance of both the 30 nm and the 10 nm nanofiltration membranes for rejection of iron is very noticeable. Specifically, the 30 nm membrane achieved a rejection of 91% of the iron, while the 10 nm membrane achieved 99% rejection of iron. This is particularly advantageous for processing in a follow-on hydrotreating step, because iron is an especially undesired component in hydrotreating steps.

TABLE III

| | Feed | Permeate | Retentate | Rejection |
|---|---|---|---|---|
| Element | (mg/kg) | (mg/kg) | (mg/kg) | (%) |
| Al | 0.5 ± 0.16 | <0.03 | <0.03 | 97 |
| Ca | 10.3±0.5 | 0.9 ± 0.05 | 27.3 ± 1.4 | 91.3 |
| Cu | <0.1 | 0.2 ± 0.1 | 0.3 ± 0.1 | |
| Fe | 5.6 ± 0.3 | 0.5 ± 0.3 | 32.0 ± 1.6 | 91.1 |
| Mg | 2.5 ± 0.13 | 0.4 ± 0.03 | 9.2 ± 0.46 | 84.0 |
| Mn | 0.1 ± 0.05 | <0.05 | 0.7 ± 0.05 | 75.0 |
| Na | 18 ± 3 | 11 ± 3 | 38 ± 3 | 38.9 |
| P | 30.1 ± 1.5 | 7.0 ± 0.5 | 59.0 ± 3.0 | 76.7 |
| Si | 1.1 ± 0.3 | 0.9 ± 0.3 | 3.0 ± 0.3 | 18.2 |
| Zn | 0.5 ± 0.3 | <0.3 | 3.0 ± 0.3 | 70.0 |
| TOTAL | 68.7 | 26.2 | 213.7 | 61.9 |

TABLE IV

| | Feed | Permeate | Retentate | Rejection |
|---|---|---|---|---|
| Element | (mg/kg) | (mg/kg) | (mg/kg) | (%) |
| Al | 0.5 ± 0.16 | <0.03 | <0.03 | 98.0 |
| Ca | 10.3 ± 0.5 | 0.5 ± 0.03 | 28.1 ± 1.4 | 95.1 |
| Cu | <0.1 | 0.2 ± 0.1 | 0.4 ± 0.1 | |
| Fe | 5.6 ± 0.3 | <0.1 | 34.0 ± 1.7 | 99.1 |
| Mg | 2.5 ± 0.13 | 0.1 ± 0.03 | 10.0 ± 0.5 | 96.0 |
| Mn | 0.1 ± 0.05 | <0.03 | 0.8 ± 0.04 | 85.0 |
| Na | 18 ± 3 | 9 ± 3 | 40 ± 3 | 50.0 |
| P | 30.1 ± 1.5 | 5.0 ± 0.3 | 63.0 ± 3.2 | 83.4 |
| Si | 1.1 ± 0.3 | NA | 3.0 ± 0.3 | |
| Zn | 0.5 ± 0.3 | <0.3 | 4.0 ± 0.3 | 80.0 |
| TOTAL | 68.7 | 19.2 | 224.5 | 72.1 |

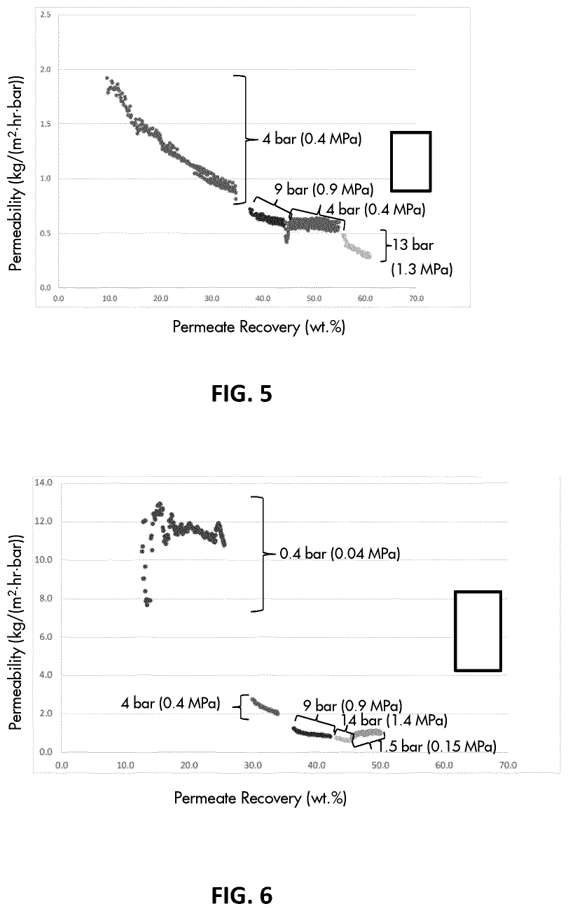

FIGS. 5 and 6 illustrate the effect of pressure on permeate recovery for the 10 nm and 30 nm nanofiltration membranes, respectively, Example 2 was conducted without a backpulse. Accordingly, FIGS. 5 and 6 illustrate a flux or permeability decline at increasing recovery.

### Example 3

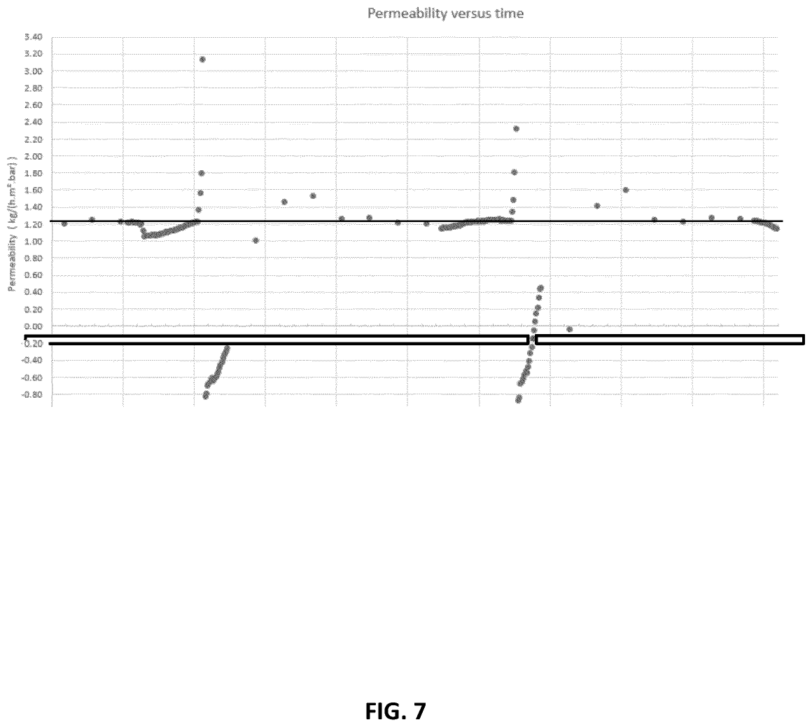

Example 2 was repeated on the 10 nm membrane with backpulses of pressure approximately 20 minutes apart. FIG. 7 shows permeability versus time for the process with backpulsing. FIG. 7 illustrates that the permeability decline can be counteracted with backpulses.

While the embodiments are described with reference to various implementations and exploitations, it will be understood that these embodiments are illustrative and that the scope of the inventive subject matter is not limited to them. Many variations, modifications, additions and improvements are possible. Various combinations of the techniques provided herein may be used.

1. A process for pre-treating renewable feedstocks for the production of fuels and/or chemicals, the process comprising the steps of:
providing an oil derived from a renewable source, the oil having a contaminant;
providing a nanofiltration membrane; and
filtering the oil with the nanofiltration membrane to produce a permeate oil having a reduced concentration of the contaminant.

2. The process according to claim 1, wherein the nanofiltration membrane has an average size of at most 30 nm, preferably in a range of from 5 nm to 30 nm, more preferably in a range of from 10 to 30 nm.

3. The process according to claim 1, wherein the nanofiltration membrane has a molecular weight cut-off value in a range of from 8,000 to 100,000 Da, more preferably in a range of from 8,500 to 20,000 Da.

4. The process according to claim 1, wherein the nanofiltration membrane is a ceramic nanofiltration membrane.

5. The process according to claim 2, wherein the ceramic nanofiltration is a functionalized ceramic membrane.

6. The process according to claim 1, wherein the nanofiltration membrane is a composite of a polymer and a support selected from the group consisting up porous polymer, a porous cross-linked polymer, a porous pyrolyzed polymer, a porous pyrolyzed cross-linked polymer, a porous metallic structure, a hybrid metallic-polymer porous structure, a porous ceramic structure, and combinations thereof.

7. The process according to claim 1, wherein the nanofiltration membrane is hydrophilic.

8. The process according to claim 1, wherein the filtering step comprises a first nanofiltration membrane and a second nanofiltration membrane, wherein the first nanofiltration membrane is the same or different than the second nanofiltration membrane.

9. The process according to claim 1, wherein the contaminant is selected from free solids; phosphorus, chlorine, sodium, iron, magnesium, calcium, aluminum, copper, manganese, silicon and/or zinc, in elemental or molecular form; phospholipids, and combinations thereof.

10. The process according to claim 1, wherein the oil derived from a renewable source is selected from vegetable oils, animal oils, and combinations thereof.

11. The process according to claim 10, wherein the oil derived from a renewable source is selected from the group consisting of tallow, used cooking oil, and combinations thereof.

12. The process according to claim 1, further comprising the step of periodically backpulsing the nanofiltration membrane, preferably wherein the backpulsing is conducted with a pulse of pressure in a range of from 10 to 15 bar (1 to 1.5 MPa), preferably for a pulse time in a range from 1 to 5 seconds, preferably on a periodic basis in a range of from 10 to 30 minutes.

13. The process according to claim 1, further comprising the step of backwashing the nanofiltration membrane.

14. The process according to claim 1, further comprising the steps of removing solids before filtering the oil with the nanofiltration membrane by pre-coat filtration, conventional backwash filtration, centrifuge, a self-cleaning filtration unit, and combinations thereof, preferably by providing a self-cleaning filter and directing the oil to the self-cleaning filter before filtering the oil with the nanofiltration membrane.

15. The process according to claim 13, further comprising the step of periodically backwashing the self-cleaning filter.
